(19) United States
(12) Patent Application Publication
(10) Pub. No.: US 2015/0288899 A1
(43) Pub. Date: Oct. 8, 2015

(54) IMAGE PICKUP APPARATUS AND METHOD FOR DRIVING THE SAME

(71) Applicant: CANON KABUSHIKI KAISHA, Tokyo (JP)

(72) Inventors: Kazuyuki Shigeta, Yokohama-shi (JP); Keisuke Ota, Tokyo (JP)

(21) Appl. No.: 14/579,546

(22) Filed: Dec. 22, 2014

(30) Foreign Application Priority Data
Dec. 25, 2013 (JP) 2013-267147

(51) Int. Cl. H04N 5/369; H04N 5/232

(52) U.S. Cl. CPC H04N 5/369; H04N 5/23241

(57) ABSTRACT

A switch portion of a voltage supply unit is configured not to perform a switching operation over a period related to generation of a photoelectric conversion signal performed by an image pickup element or a period related to processing of a photoelectric conversion signal performed by the image pickup element.

### BACKGROUND OF THE INVENTION

1. Field of the Invention

The present invention relates to an image pickup apparatus and a method for driving the same.

2. Description of the Related Art

There are image pickup elements including pixels each configured to perform photoelectric conversion on incident light and to generate a photoelectrical conversion signal. In addition, there are image pickup apparatuses including a voltage supply unit configured to generate a driving voltage to be supplied to an image pickup element by performing a switching operation.

Japanese Patent Laid-Open No. 2008-219292 describes an image pickup apparatus that uses a DC-to-DC converter as an example of the voltage supply unit. Japanese Patent Laid-Open No. 2008-219292 also describes an image pickup apparatus configured to select, in accordance with an operation mode of the image pickup apparatus, a suitable frequency from setting information regarding a plurality of switching frequencies prepared in advance and to drive the DC-to-DC converter at the selected frequency.

### SUMMARY OF THE INVENTION

One aspect of the present invention provides an image pickup apparatus including: an image pickup element including pixels each configured to generate a photoelectric conversion signal based on an electric charge resulting from photoelectric conversion on incident light; a first voltage supply unit configured to receive an input voltage and to supply the image pickup element with a driving voltage obtained by changing a voltage value of the input voltage; a controller configured to control an operation performed by the first voltage supply unit, wherein the first voltage supply unit includes a first capacitive element, and a first switch portion configured to perform a switching operation for switching an operation of the first capacitive element between charging and discharging, the driving voltage is a voltage obtained by changing a voltage value of the input voltage through the switching operation, and the controller performs control so that the first switch portion does not perform the switching operation over a period related to generation of a photoelectric conversion signal or a period related to processing of a photoelectric conversion signal.

Another aspect of the present invention provides a method for driving an image pickup apparatus, the image pickup apparatus including an image pickup element including pixels each configured to generate a photoelectric conversion signal based on an electric charge resulting from photoelectric conversion on incident light and a voltage supply unit configured to receive an input voltage and to supply the image pickup element with a driving voltage obtained by changing a voltage value of the input voltage, the voltage supply unit including a first capacitive element, the method including: changing the voltage value of the input voltage by switching an operation of the first capacitive element between charging and discharging to obtain the driving voltage; and performing control so that the operation of the first capacitive element is not switched between charging and discharging over a period related to generation a photoelectric conversion signal or a period related to processing of a photoelectric conversion signal.

Further features of the present invention will become apparent from the following description of exemplary embodiments with reference to the attached drawings.

### BRIEF DESCRIPTION OF THE DRAWINGS

FIG. 1 is a diagram illustrating an example of a configuration of an image pickup apparatus.

FIG. 2 is a diagram illustrating an example of a configuration of an image pickup element.

FIG. 3 is a diagram illustrating an example of a configuration of a pixel.

FIG. 4 is a diagram illustrating an example of an operation performed by the image pickup element.

FIG. 5 is a diagram illustrating an example of an operation performed by an image pickup apparatus according to a comparative example.

FIG. 6A is a diagram illustrating an example of an operation performed by the image pickup apparatus and FIG. 6B is a diagram illustrating another example of an operation performed by the image pickup apparatus.

FIG. 7 is a diagram illustrating an example of an operation performed by the image pickup apparatus.

FIG. 8 is a diagram illustrating an example of a configuration of the image pickup element.

FIG. 9 is a diagram illustrating an example of a configuration of a ramp signal supply unit.

FIG. 10 is a diagram illustrating an example of an operation performed by the image pickup apparatus.

FIG. 11 is a diagram illustrating an example of a configuration of an image pickup apparatus.

FIG. 12 is a diagram illustrating an example of a configuration of an image pickup apparatus.

### DESCRIPTION OF THE EMBODIMENTS

In the image pickup apparatus described in Japanese Patent Laid-Open No. 2008-219292, the power supply unit may perform a switching operation during a period related to generation or processing of a photoelectric conversion signal performed by the image pickup element. In this case, noise produced by the switching operation performed by the voltage supply unit is undesirably added to the photoelectric conversion signal or a signal based on the photoelectric conversion signal.

Exemplary embodiments described below relate to a technique that makes noise produced by a switching operation performed by a voltage supply unit less likely to be added to a photoelectric conversion signal or a signal based on the photoelectric conversion signal.

Each exemplary embodiment will be described below with reference to the accompanying drawings.

### First Exemplary Embodiment

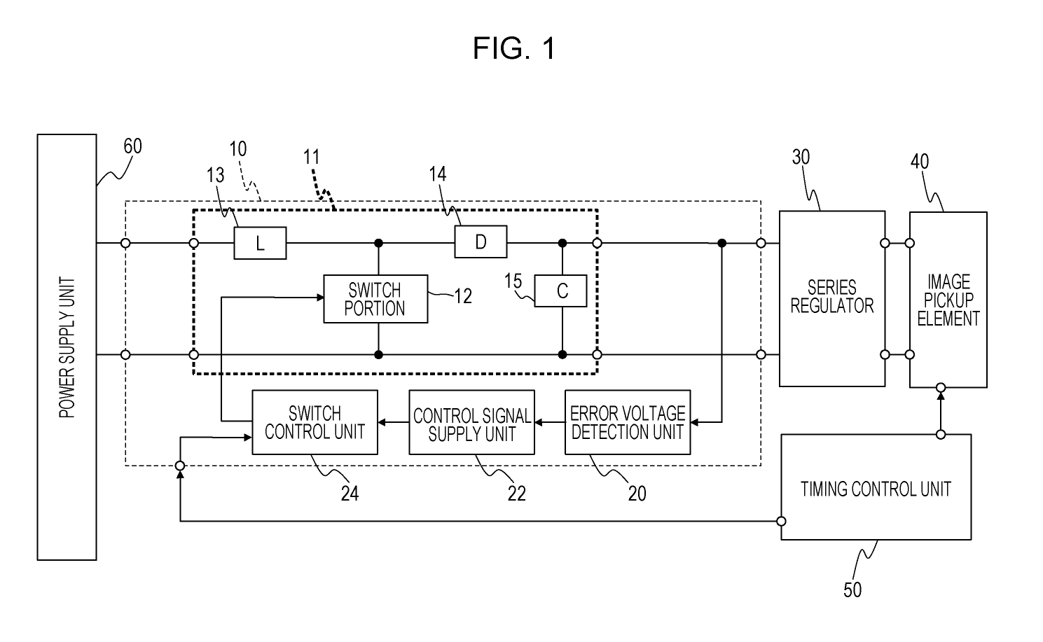

FIG. 1 is a diagram illustrating a configuration of an image pickup apparatus according to a first exemplary embodiment.

The image pickup apparatus according to the first exemplary embodiment includes a voltage supply unit 10, a series regulator 30, an image pickup element 40, a timing control unit 50, and a power supply unit 60.

The voltage supply unit 10 raises a voltage input thereto from the power supply unit 60 and outputs the resulting voltage to the series regulator 30. In the first exemplary embodiment, the voltage supply unit 10 may be a DC-to-DC converter. The voltage supply unit 10 includes a rectifying/smoothing unit 11. The rectifying/smoothing unit 11 includes a switch portion 12, an inductor 13, a diode 14, and a capacitive element 15. The switch portion 12 may be a switch configured to switch the operation of the capacitive element 15 between charging and discharging. The voltage supply unit 10 further includes an error voltage detection unit 20, a control signal supply unit 22, and a switch control unit 24. The control signal supply unit 22 outputs a control signal PX used to control a switching operation performed by the switch portion 12, in accordance with a detection result signal input thereto from the error voltage detection unit 20. The switch control unit 24 outputs, to the switch portion 12, a control signal PG which is generated based on the control signal PX input thereto from the control signal supply unit 22 and a timing signal TIM input thereto from the timing control unit 50.

The series regulator 30 lowers, rectifies, and smoothes a driving voltage output by the voltage supply unit 10 and outputs the resulting voltage to the image pickup element 40.

The image pickup element 40 operates in accordance with the driving voltage supplied thereto from the voltage supply unit 10 via the series regulator 30. The image pickup element 40 generates photoelectric conversion signals based on incident light under control of the timing control unit 50. The image pickup element 40 then outputs, to outside the image pickup element 40, signals based on the photoelectric conversion signals under control of the timing control unit 50.

The timing control unit 50 controls the image pickup element 40 and outputs the timing signal TIM to the switch control unit 24.

The power supply unit 60 supplies the voltage supply unit 10 with a power supply voltage from which the driving voltage supplied to the image pickup element 40 from the voltage supply unit 10 via the series regulator 30 is generated.

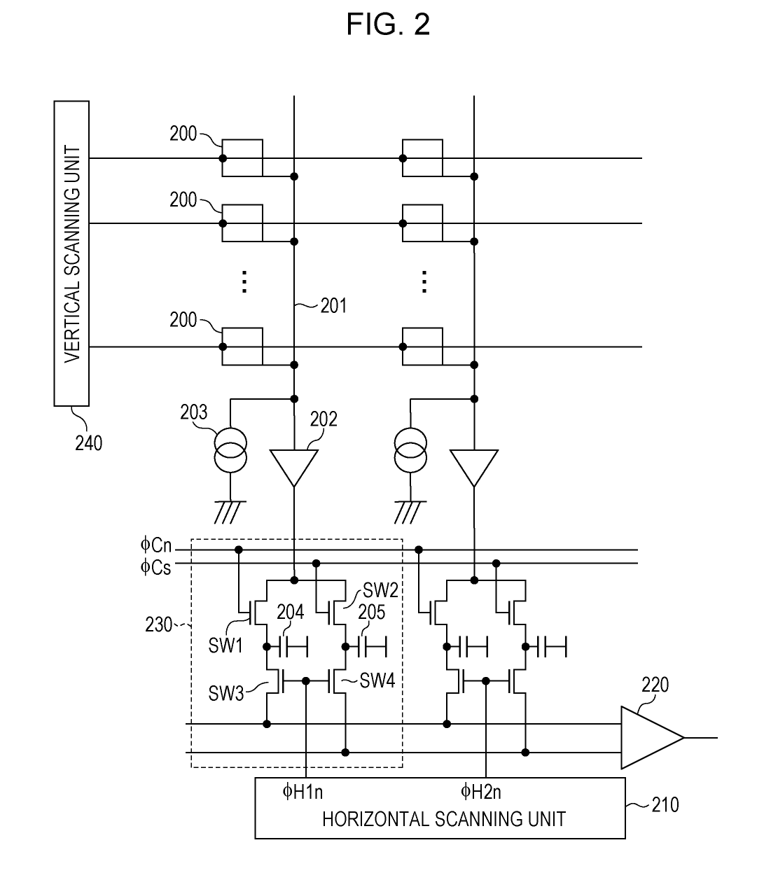

FIG. 2 is a diagram illustrating a configuration of the image pickup element 40 illustrated in FIG. 1.

The image pickup element 40 includes pixels 200 arranged in a matrix. FIG. 2 illustrates the pixels 200 on two columns. In FIG. 2, reference signs are assigned to components related to one column of the pixels 200. Components related to the adjacent column of the pixels 200 are similar to components related to the one column of the pixels 200 assigned reference signs. The following describes the components related to the one column of the pixels 200 assigned reference signs.

Each of the pixels 200 outputs a noise signal and a photoelectric conversion signal based on incident light to an amplifier 202 via a vertical signal line 201. A current source 203 supplies a current to the pixels 200 via the vertical signal line 201.

A signal processing unit 230 includes capacitive elements 204 and 205; and switches SW1, SW2, SW3, and SW4. A timing generator (not illustrated) supplies a signal φCn to a control node of the switch SW1. The timing generator (not illustrated) also supplies a signal φCs to a control node of the switch SW2. A horizontal scanning unit 210 supplies a signal φH1n to control nodes of the switches SW3 and SW4. The horizontal scanning unit 210 also supplies a signal φH2n to control nodes of the switches SW3 and SW4 on the column adjacent to the one supplied with the signal φ1n.

An output amplifier 220 is electrically connected to the capacitive element 204 via the switch SW3 and to the capacitive element 205 via the switch SW4. The output amplifier 220 outputs, to outside the image pickup element 40, a signal obtained by amplifying a differential signal of the signals input thereto from the capacitive elements 204 and 205.

A vertical scanning unit 240 controls operations of the pixels 200 on a row-by-row basis.

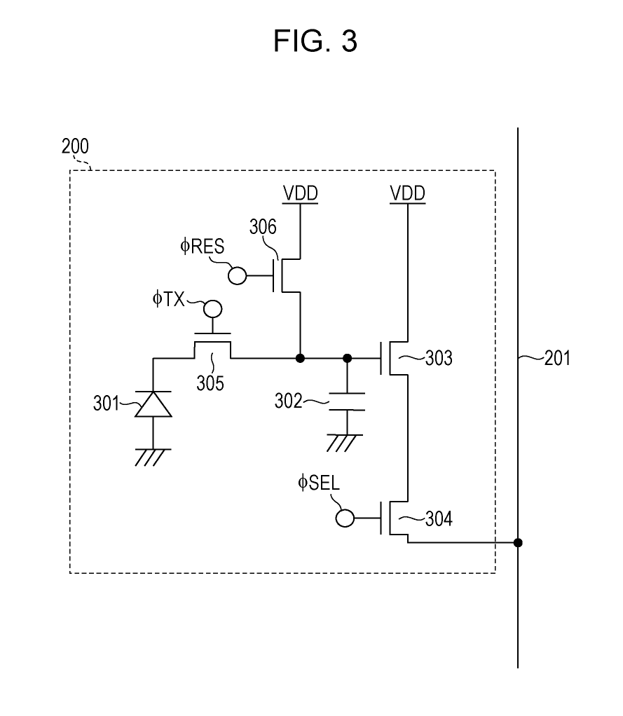

FIG. 3 is a diagram illustrating a configuration of each of the pixels 200. Each of the pixels 200 includes a photoelectric conversion portion 301, a floating diffusion portion 302, and transistors 303 to 306. The photoelectric conversion portion 301 accumulates electric charge based on incident light. The floating diffusion portion 302 is electrically connected to the photoelectric conversion portion 301 via the transistor 305. The floating diffusion portion 302 is also electrically connected to an input node of the transistor 303. The transistor 303 has principal nodes, one of which is electrically connected to one of principal nodes of the transistor 304 and the other of which is supplied with a power supply voltage VDD. The transistor 303 serves as a pixel output portion configured to output a photoelectric conversion signal which is a signal based on electric charge in the floating diffusion portion 302. The other principal node of the transistor 304 is electrically connected to the vertical signal line 201. The transistor 306 has principal nodes, one of which is supplied with the power supply voltage VDD and the other of which is electrically connected to the floating diffusion portion 302. The vertical scanning unit 240 illustrated in FIG. 2 supplies a signal φTX to a control node of the transistor 305, a signal φSEL to a control node of the transistor 304, and a signal φRES to a control node of the transistor 306.

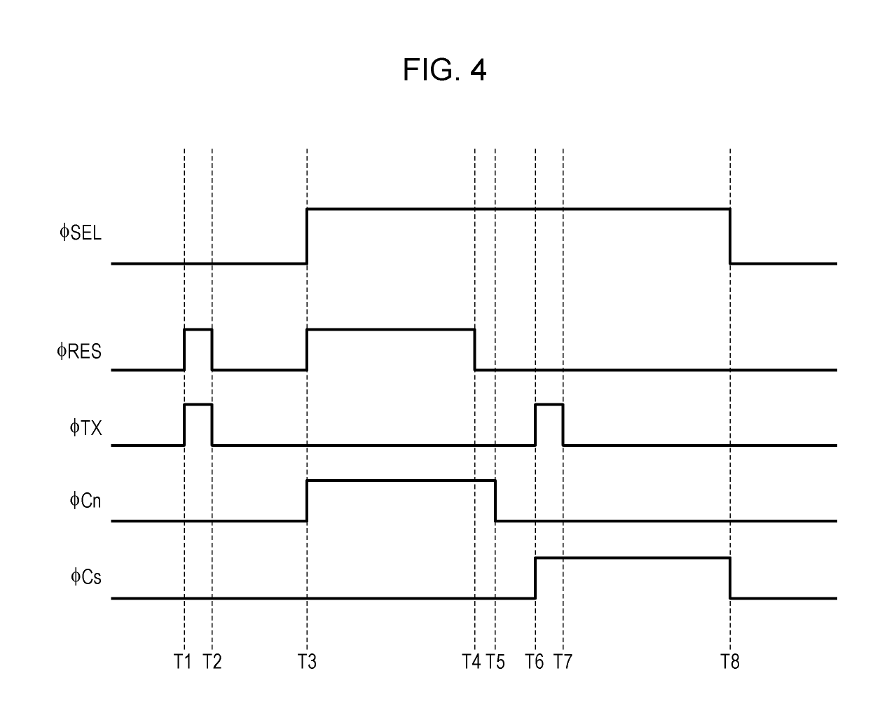

FIG. 4 is a diagram illustrating an operation of the image pickup element 40 illustrated in FIG. 2. At time T1, the vertical scanning unit 240 makes the signals φRES and φTX have a high level (hereinafter, referred to as an “H level”). This consequently resets electric charge in the photoelectric conversion portion 301 and the floating diffusion portion 302. At time T1, the vertical scanning unit 240 keeps the signal φSEL at a low level (hereinafter, referred to as an “L level”). In addition, the timing generator (not illustrated) keeps the signals φCn and φCs at the L level.

At time T2, the vertical scanning unit 240 makes the signals φRES and φTX have the L level. In addition, at time T2, the timing generator keeps the signals φCn and φCs at the L level.

At time T3, the vertical scanning unit 240 makes the signal φRES have the H level. This consequently resets electric charge in the floating diffusion portion 302 in the pixel 200. The vertical scanning unit 240 also makes the signal φSEL have the H level. This consequently causes the transistor 303 to output a signal based on a potential at the reset floating diffusion portion 302 to the vertical signal line 201 via the transistor 304. In addition, at time T3, the timing generator makes the signal φCn have the H level. This consequently causes a signal output by the amplifier 202 to be input to the capacitive element 204.

At time T4, the vertical scanning unit 240 makes the signal φRES have the L level. This consequently terminates the resetting of the floating diffusion portion 302. A signal output by the transistor 303 from time T4 is a noise signal (hereinafter, referred to as an “N signal”). The amplifier 202 outputs a signal (hereinafter, referred to as an “amplified N signal”) obtained by amplifying the N signal. The amplified N signal corresponds to a signal based on a noise signal.

At time T5, the timing generator makes the signal φCn have the L level. At this time, the capacitive element 204 holds the amplified N signal input thereto from the amplifier 202.

At time T6, the vertical scanning unit 240 makes the signal φTX have the H level. This consequently causes electric charge accumulated in the photoelectric conversion portion 301 to be input to the floating diffusion portion 302 via the transistor 305. In addition, at time T6, the timing generator makes the signal φCs have the H level. This consequently causes the signal output by the amplifier 202 to be input to the capacitive element 205.

At time T7, the vertical scanning unit 240 makes the signal φTX have the L level. This consequently terminals inputting of electric charge from the photoelectric conversion portion 301 to the floating diffusion portion 302. A signal output by the transistor 303 from time T7 is a photoelectric conversion signal (hereinafter, referred to as an “S signal”). The amplifier 202 outputs a signal (hereinafter, referred to as an “amplified S signal”) obtained by amplifying the S signal. In this exemplary embodiment, a period related to generation of a photoelectric conversion signal corresponds to a period for which the signal φTX is kept at the H level which is a period for which electric charge is transferred from the photoelectric conversion portion 301 to the floating diffusion portion 302. In addition, the amplified S signal corresponds to a signal based on a photoelectric conversion signal.

At time T8, the timing generator makes the signal φCs have the L level. At this time, the capacitive element 205 holds the amplified S signal input thereto from the amplifier 202.

After time T8, the horizontal scanning unit 210 sequentially makes signals φH1n and φH2n have the H level. This consequently causes the amplified N signal and the amplified S signal respectively held by the capacitive elements 204 and 205 on each column to be sequentially output to the output amplifier 220. The output amplifier 220 outputs a signal obtained by amplifying a differential signal of the amplified S signal and the amplified N signal to outside the image pickup element 40.

A description will be given of a comparative example where the switch portion 12 of the voltage supply unit 10 illustrated in FIG. 1 performs a switching operation to switch the operation of the capacitive element 15 between charging and discharging while the signal φTX is at the H level. In the comparative example, the voltage supply unit 10 does not include the switch control unit 24. The switching operation performed by the switch portion 12 is controlled in accordance with the control signal PX output by the control signal supply unit 22 alone.

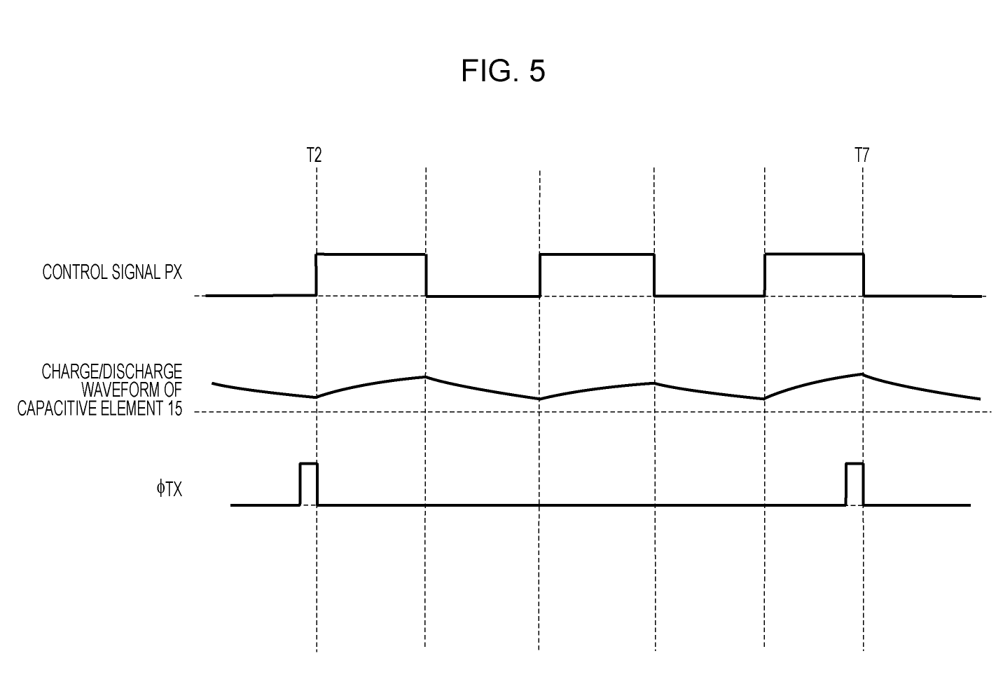

FIG. 5 is a diagram of the comparative example illustrating the control signal PX output by the control signal supply unit 22, a charge/discharge waveform of the capacitive element 15, and the signal φTX. The control signal PX alternates between the H level and the L level at a certain frequency. While the control signal PX is at the H level, the switch portion 12 causes the capacitive element 15 to be charged; while the control signal PX is at the L level, the switch portion 12 causes the capacitive element 15 to be discharged.

Time T7 in FIG. 5 corresponds to time T7 in FIG. 4. At time T7, the control signal PX changes from the H level to the L level. In response to this change, the switch portion 12 switches the operation of the capacitive element 15 from discharging to charging. If the timing at which the operation of the capacitive element 15 is switched overlaps a timing at which the signal φTX is at the H level, noise produced by the operation switching of the capacitive element 15 is added to electric charge input from the photoelectric conversion portion 301 to the floating diffusion portion 302. The noise produced by the operation switching of the capacitive element 15 includes radiated noise and conducted noise produced by a switching operation performed by the switch portion 12. Radiated noise is electromagnetic noise produced by a switching operation performed by the switch portion 12. Conducted noise is produced in the following manner. The driving voltage output by the voltage supply unit 10 temporarily varies due to a switching operation performed by the switch portion 12, and this variation propagates to the image pickup element 40 via a wiring that supplies the driving voltage to cause noise. This noise is conducted noise. These types of noise are added to electric charge held by the floating diffusion portion 302, increasing a noise component in an S signal. Noise produced by a switching operation is contained in common in individual S signals of the pixels 200 on one row. As a result, a horizontal streak is caused in an image generated based on the signals output by the image pickup element 40, decreasing the image quality.

In addition, like at time T7, the switch portion 12 may perform a switching operation at time T2 when the signal φTX is at the H level. In this case, noise produced by a switching operation is also added to an N signal. However, when the noise component contained in the S signal is not equal to the noise component contained in the N signal, it is difficult to accurately subtract the noise component resulting from noise produced by a switching operation of the switch portion 12 from the S signal by subtracting the N signal from the S signal. As a result, a horizontal streak is also caused in a generated image in this case, decreasing the image quality.

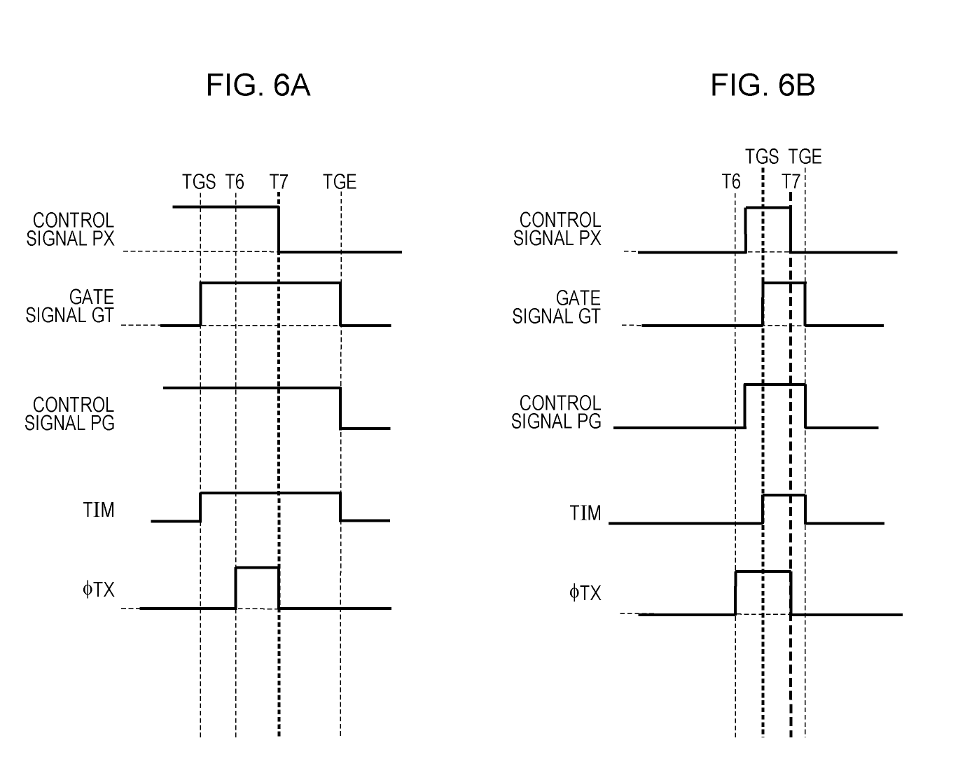

Referring next to FIGS. 6A and 6B, an operation of the image pickup apparatus according to the first exemplary embodiment will be described.

FIG. 6A is a diagram illustrating the control signal PX, the control signal PG output by the switch control unit 24, and the signal φTX. Times T6 and T7 in FIG. 6A respectively correspond to times T6 and T7 in FIG. 4. While the timing signal TIM illustrated in FIG. 6A is at the L level, the switch control unit 24 outputs the control signal PX as the control signal PG. While the timing signal TIM is at the H level, the switch control unit 24 outputs a gate signal GT as the control signal PG.

The timing control unit 50 illustrated in FIG. 1 keeps the timing signal TIM at the H level over a period from time TGS to time TGE, which includes a period from time T6 to time T7 over which the signal φTX is kept at the H level. Upon receipt of the H-level timing signal TIM, the switch control unit 24 changes the signal level of the gate signal GT at time TGS to be equal to the signal level of the control signal PX at time TGS. The switch control unit 24 keeps the signal level of the gate signal GT at the signal level of the control signal PX sampled at time TGS while the timing signal TIM is at the H level. Accordingly, as illustrated in FIG. 6A, the signal level of the control signal PG output by the switch control unit 24 is kept at the H level from time prior to time TGS to time TGE, and changes from the H level to the L level at time TGE. Consequently, the switch portion 12 does not perform a switching operation while the signal φTX is kept at the H level and performs a switching operation at time TGE.

This configuration allows the image pickup apparatus according to the first exemplary embodiment to obtain an S signal in which noise produced by a switching operation performed by the switch portion 12 is reduced.

In FIG. 6A, the period from time TGS to time TGE includes the period from time T6 to time T7. Alternatively, time TGS at which the timing signal TIM becomes the H level may be set between time T6 and time T7 as illustrated in FIG. 6B. In the case illustrated in FIG. 6B, after time T6, the signal level of the control signal PX changes from the L level to the H level and the control signal PG similarly changes to the H level. The switch portion 12 performs a switching operation in response to the change of the control signal PG from the L level to the H level. Thereafter, at time TGS, the gate signal GT becomes the H level in accordance with the H-level control signal PX. The gate signal GT is kept at the H level up until time TGE which is after time T7. Accordingly, even if the control signal PX becomes the L level at time T7, the control signal PG is kept at the H level at and after time T7. In this case, the switch portion 12 does not perform a switching operation at time T7 at which electric charge held by the floating diffusion portion 302 is decided. Thus, in this case, an S signal in which noise produced by a switching operation of the switch portion 12 is reduced can be obtained. Accordingly, in the image pickup apparatus according to the first exemplary embodiment, a configuration is made such that the switch portion 12 does not perform a switching operation at least at time T7.

In addition, as in the cases illustrated in FIGS. 6A and 6B, a configuration is made such that the switch portion 12 does not perform a switching operation also at time T2 at which the signal level of the signal φTX is changed from the H level to the L level to obtain an N signal, which has been described in FIG. 4. In this case, the image pickup apparatus according to the first exemplary embodiment can obtain an N signal in which noise produced by a switching operation of the switch portion 12 is reduced.

In the image pickup apparatus according to the first exemplary embodiment, the switch portion 12 does not perform a switching operation over a period related to generation of a photoelectric conversion signal (e.g., a period for which electric charge is transferred from the photoelectric conversion portion 301 to the floating diffusion portion 302). The period related to generation of a photoelectric conversion signal over which the switch portion 12 does not perform a switching operation is a period for which noise produced by a switching operation of the switch portion 12 is likely to be added to the photoelectric conversion signal when the photoelectric conversion signal is generated. The period for which the switch portion 12 of the image pickup apparatus according to the first exemplary embodiment does not perform a switching operation can be a period for which a signal value of the photoelectric conversion signal is obtained.

In the first exemplary embodiment, in order to configure the switch portion 12 not to perform a switching operation, a signal that is kept at a sampled signal value of the control signal PX is used as the gate signal GT while the timing signal TIM is at the H level. Alternatively, the switch control unit 24 may output, to the switch portion 12, a signal for preventing a switching operation over the period for which the switch portion 12 does not perform a switching operation.

### Second Exemplary Embodiment

An image pickup apparatus according to a second exemplary embodiment will be described in terms of a difference from the image pickup apparatus according to the first exemplary embodiment.

The image pickup apparatus according to the second exemplary embodiment has a configuration illustrated in FIG. 1. The image pickup element 40 has a configuration illustrated in FIG. 2. Each of the pixels 200 has a configuration illustrated in FIG. 3. An operation of the image pickup apparatus is illustrated in FIG. 4.

The image pickup apparatus according to the second exemplary embodiment is different from the image pickup apparatus according to the first exemplary embodiment in that the switch portion 12 is configured not to perform a switching operation while the signal φCs is at the H level.

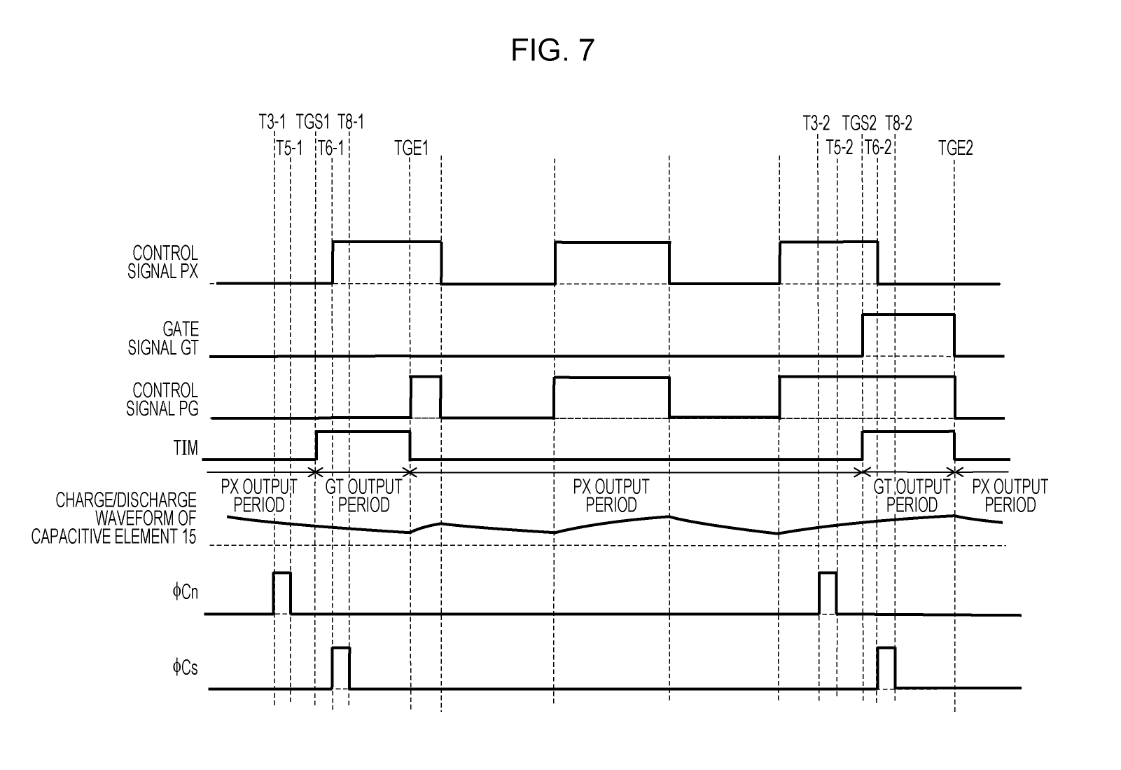

FIG. 7 is a diagram illustrating an operation performed by the image pickup apparatus according to the second exemplary embodiment.

At time T3-1 illustrated in FIG. 7, the image pickup apparatus performs the operation performed at time T3 in FIG. 4, as an operation for the pixels 200 on the first row. In addition, at time T3-2, the image pickup apparatus performs the operation performed at time T3 in FIG. 4, as an operation for the pixels 200 on the second row. Similarly, at time T5-1, time T6-1, and time T8-1, the operations performed at time T5, time T6, and time T8 in FIG. 4 are performed as operations for the pixels 200 on the first row. Likewise, at time T5-2, time T6-2, and time T8-2, the operations performed at time T5, T6, and T8 in FIG. 4 are performed as operations for the pixels 200 on the second row.

In the second exemplary embodiment, the timing control unit 50 makes the timing signal TIM have the H level at time TGS1 which is prior to time T6-1 at which the signal φCs becomes the H level. Upon receipt of the H-level timing signal TIM, the switch control unit 24 changes the signal level of the gate signal GT at time TGS1 to be equal to the signal level of the control signal PX at time TGS1. While the timing signal TIM is at the H level, the signal level of the gate signal GT is kept at the signal level of the control signal PX sampled at time TGS1. Also, while the timing signal TIM is at the H level, the switch control unit 24 outputs the signal level of the gate signal GT instead of the signal level of the control signal PX to the switch portion 12 as the control signal PG. Consequently, the switch portion 12 does not perform a switching operation while the signal φCs is at the H level. In the second exemplary embodiment, a period related to processing of a photoelectric conversion signal is a period for which the signal φCs is kept at the H level which is a period for which the capacitive element 205 holds an amplified S signal.

Accordingly, in the image pickup apparatus according to the second exemplary embodiment, the switch portion 12 does not perform a switching operation while the capacitive element 205 holds an amplified S signal. This configuration allows the image pickup apparatus according to the second exemplary embodiment to obtain an amplified S signal in which noise produced by a switching operation of the switch portion 12 is reduced.

As for a period from time T6-2 to time T8-2, the signal level of the control signal PG is kept at the signal level of the gate signal GT over a period from time TGS2 to time TGS2 which includes the period from time T6-2 to time 8-2. This configuration can reduce noise produced by a switching operation of the switch portion 12 in an amplified S signal based on an S signal obtained by each pixel 200 on the second row.

In the image pickup apparatus according to the second exemplary embodiment, the period from time TGS1 to time TGE1 includes the period from time T6-1 to time T8-1. Alternatively, time TGS1 at which the timing control unit 50 makes the timing signal TIM have the H level may be set between time T6-1 and time T8-1 and time TGE1 at which the timing control unit 50 makes the timing signal TIM have the L level may be set to time after time T8-1. In this case, the switch portion 12 also does not perform a switching operation at time T8-1 at which the signal value of an amplified S signal held by the capacitive element 205 is decided. In this case, an amplified S signal in which noise produced by a switching operation of the switch portion 12 is reduced can also be obtained.

As described in the first exemplary embodiment, a configuration is made such that the switch portion 12 does not perform a switching operation while the signal φTX is at the H level also in the second exemplary embodiment.

In the image pickup apparatus according to the second exemplary embodiment, the switch portion 12 does not perform a switching operation over the period related to processing of a photoelectric conversion signal (e.g., a period for which the capacitive element 205 holds an amplified S signal). The period related to processing of a photoelectric conversion signal over which the switch portion 12 does not perform a switching operation is a period for which noise produced by a switching operation of the switch portion 12 is likely to be added to the photoelectric conversion signal, such as a period for which an operation for holding a photoelectric conversion signal and an operation for amplifying the photoelectric conversion signal are performed. The period for which the switch portion 12 of the image pickup apparatus according to the second exemplary embodiment does not perform a switching operation can be a period for which the signal processing unit 230 obtains a signal value of a signal based on a photoelectric conversion signal.

### Third Exemplary Embodiment

An image pickup apparatus according to a third exemplary embodiment will be described in terms of a difference from the image pickup apparatus according to the first exemplary embodiment.

The image pickup apparatus according to the third exemplary embodiment has a configuration illustrated in FIG. 1. Each of the pixels 200 has a configuration illustrated in FIG. 3.

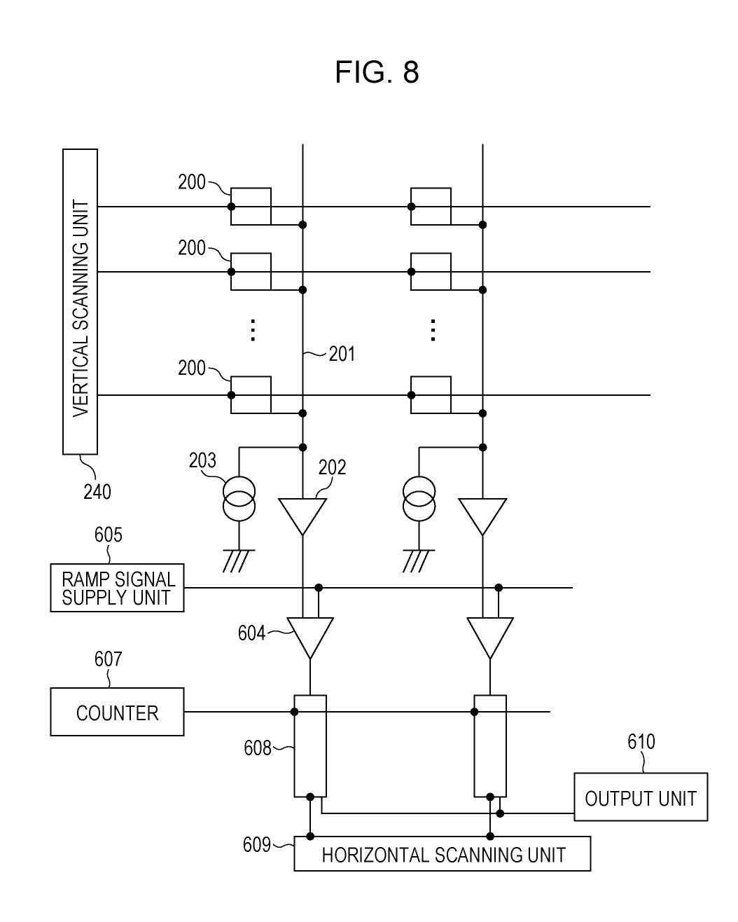

FIG. 8 is a diagram illustrating a configuration of the image pickup element 40 according to the third exemplary embodiment.

In FIG. 8, components of the image pickup element 40 having similar functions as those illustrated in FIG. 2 are denoted by the same reference signs as those used in FIG. 2.

The image pickup element 40 includes comparators 604, a ramp signal supply unit 605, a counter 607, memory units 608, a horizontal scanning unit 609, and an output unit 610. In the third exemplary embodiment, each analog-to-digital (A/D) converter includes the comparator 604 and the memory unit 608.

The ramp signal supply unit 605 is connected to the plurality of comparators 604 and supplies a ramp signal VRAMP. The ramp signal VRAMP is a signal having a potential that continuously changes over time. The ramp signal VRAMP is a reference signal used by the A/D converter to perform A/D conversion. The ramp signal supply unit 605 corresponds to a reference signal supply unit.

The comparators 604 are provided for the respective columns of the pixels 200.

The counter 607 is connected to the memory units 608 on the respective columns.

The memory units 608 are provided for the corresponding comparators 604 at the respective columns.

The horizontal scanning unit 609 scans the memory units 608 on the respective columns to cause signals held by the memory units 608 on the respective columns to be sequentially output from the memory units 608 to the output unit 610.

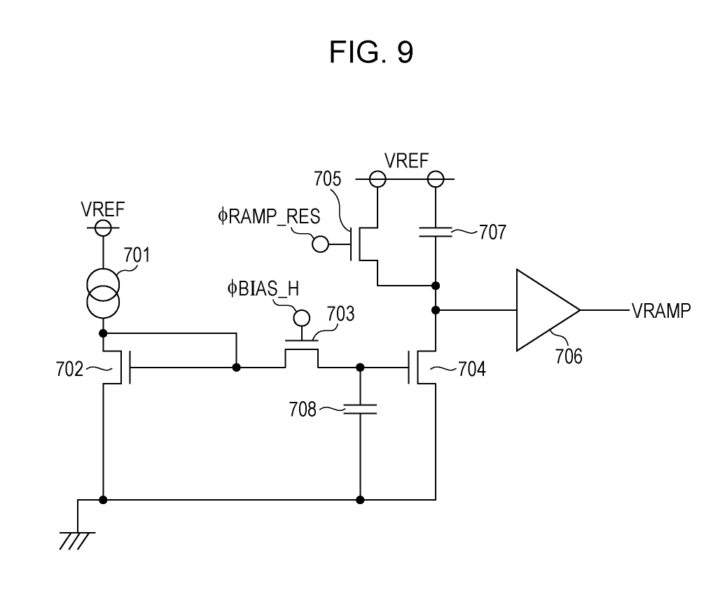

FIG. 9 is a diagram illustrating a configuration of the ramp signal supply unit 605.

The ramp signal supply unit 605 includes a current source 701, transistors 702 to 705, capacitive elements 707 and 708, and a differential amplifier 706.

The ramp signal supply unit 605 includes a current mirror circuit composed of the current source 701 and the transistor 702. The current mirror circuit is electrically connected to one of nodes of the capacitive element 708 and an input node of the transistor 704 via the transistor 703.

The other node of the capacitive element 708 is electrically connected to one of principal nodes of the transistor 702 and one of principal nodes of the transistor 704. The other principal node of the transistor 704 is electrically connected to an input node of the differential amplifier 706, one of principal nodes of the transistor 705, and one of nodes of the capacitive element 707. The other principal node of the transistor 705 and the other node of the capacitive element 707 are supplied with a voltage VREF.

A control node of the transistor 703 is supplied with a signal φBIAS_H by the timing generator. A control node of the transistor 705 is supplied with a signal φRAMP_RES.

A signal output by the differential amplifier 706 is the ramp signal VRAMP output by the ramp signal supply unit 605.

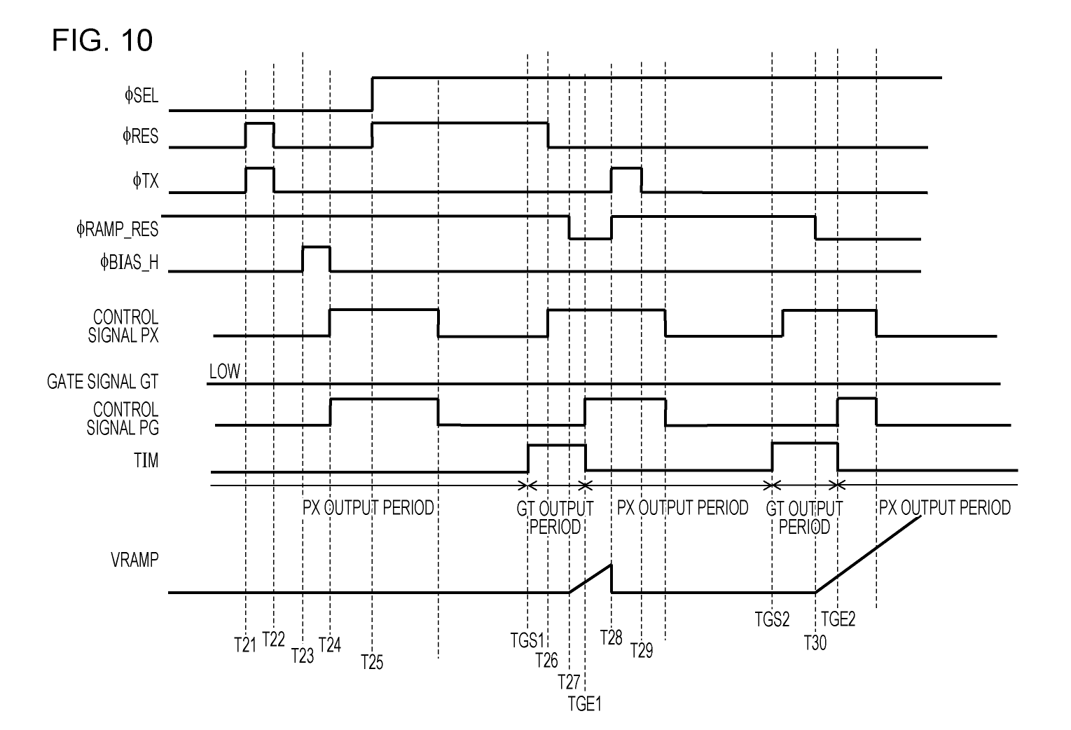

FIG. 10 is a diagram illustrating an operation of the image pickup apparatus according to the third exemplary embodiment.

At time 21, the vertical scanning unit 240 makes the signals φRES and φTX have the H level. This consequently starts resetting of electric charge in the photoelectric conversion portion 301 illustrated in FIG. 3. At time T21, the timing generator keeps the signal φRAMP_RES at the H level to reset the ramp signal VRAMP.

At time T22, the vertical scanning unit 240 makes the signals φRES and φTX have the L level. This consequently terminates resetting of electric charge in the photoelectric conversion portion 301 and causes the photoelectric conversion portion 301 to start accumulating electric charge based on incident light.

At time T23, the timing generator makes the signal φBIAS_H have the H level. Then, at time T24, the timing generator makes the signal φBIAS_H have the L level. This consequently causes the capacitive element 708 to hold a voltage output from the current mirror circuit composed of the current source 701 and the transistor 702.

At time T25, the vertical scanning unit 240 makes the signal φRES have the H level. This consequently starts resetting of electric charge in the floating diffusion portion 302 illustrated in FIG. 3. The vertical scanning unit 240 also makes the signal φSEL have the H level at time T25.

At time T26, the vertical scanning unit 240 makes the signal φRES have the L level. This consequently terminates resetting of electric charge in the floating diffusion portion 302. As a result, the pixel 200 outputs an N signal to the amplifier 202 illustrated in FIG. 8. The amplifier 202 outputs an amplified N signal obtained by amplifying the N signal to the comparator 604.

At time T27, the timing generator makes the signal φRAMP_RES have the L level. This consequently causes the potential of the ramp signal VRAMP to change in a time-dependent manner. This ramp signal VRAMP serves as a first reference signal used in A/D conversion of the amplified N signal. Time T27 is a timing at which an initial value of the first reference signal is decided. Also, the counter 607 outputs a count signal representing a count of the clock signal to the memory units 608 on the respective columns. The comparator 604 outputs, to the corresponding memory unit 608, a comparison result signal indicating a result of comparing the potential of the amplified N signal output by the amplifier 202 and the potential of the ramp signal VRAMP whose potential changes in a time-dependent manner. When the relationship in magnitude of the potentials of the amplified N signal and the ramp signal VRAMP is reversed, the signal value of the comparison result signal changes. The memory unit 608 holds the count signal when the signal value of the comparison result signal has changed. The count signal held by the memory unit 608 is a digital signal based on the amplified N signal. The digital signal based on the amplified N signal corresponds to a signal based on a noise signal.

At time T28, the timing generator makes the signal φRAMP_RES have the H level. This consequently resets the potential of the ramp signal VRAMP. In addition, the vertical scanning unit 240 makes the signal φTX have the H level. This consequently causes electric charge accumulated in the photoelectric conversion portion 301 illustrated in FIG. 3 to be transferred to the floating diffusion portion 302 via the transistor 305.

At time T29, the vertical scanning unit 240 makes the signal φTX have the L level. This consequently terminates the transfer of electric charge accumulated in the photoelectric conversion portion 301 to the floating diffusion portion 302. The pixel 200 outputs an S signal to the amplifier 202. The amplifier 202 outputs, to the comparator 604, an amplified S signal obtained by amplifying the S signal.

At time T30, the timing generator makes the signal φRAMP_RES have the L level. This consequently causes the potential of the ramp signal VRAMP to change in a time-dependent manner. This ramp signal VRAMP serves as a second reference signal used in A/D conversion of the amplified S signal. Time T30 is a timing at which an initial value of the second reference signal is decided. As a result of operations of the comparator 604, the counter 607, and the memory unit 608 similar to those performed for the amplified N signal, a digital signal based on the amplified S signal is held in the memory unit 608. The digital signal based on the amplified S signal corresponds to a signal based on a photoelectric conversion signal.

In the image pickup apparatus according to the third exemplary embodiment, the switch portion 12 does not perform a switching operation at a timing at which the timing generator changes the level of the signal φRAMP_RES from the H level to the L level. That is, in the third exemplary embodiment, the period related to processing of a photoelectric conversion signal corresponds to a period for which the timing generator sets a potential of the ramp signal VRAMP to a potential from which the time-dependent potential change starts. As illustrated in FIG. 10, the timing control unit 50 keeps the timing signal TIM at the H level over a period from time TGS1 to time TGE1 which includes a period from time T26 to time T27. As a result, the switch portion 12 does not perform a switching operation at time T27 at which the signal φRAMP_RES becomes the L level from the H level. Similarly, the timing control unit 50 keeps the timing signal TIM at the H level over a period from time TGS2 to time TGE2 in which time T30 is included. As a result, the switch portion 12 does not perform a switching operation at time T30 at which the signal φRAMP_RES becomes the L level from the H level.

If the switch portion 12 performs a switching operation at time T27 or T30 at which the signal φRAMP_RES becomes the L level from the H level, noise produced by the switching operation changes an amount of electric charge held by the capacitive element 707. As a result, an offset component resulting from the switching operation of the switch portion 12 is added to the ramp signal VRAMP. This thus causes the offset component resulting from the switching operation of the switch portion 12 to be contained in the digital signals based on the amplified N signal and on the amplified S signal. The offset components resulting from the switching operation of the switch portion 12 that are contained in the digital signal based on the amplified N signal and the digital signal based on the amplified S signal may be different from each other. In such a case, it is difficult to accurately subtract the offset component resulting from the switching operation of the switch portion 12 by subtracting the digital signal based on the amplified N signal from the digital signal based on the amplified S signal. As a result, a horizontal streak is caused in an image generated using signals output by the image pickup element 40, decreasing the image quality.

In contrast, in the image pickup apparatus according to the third exemplary embodiment, the switch portion 12 is configured not to perform a switching operation at a timing at which the signal φRAMP_RES becomes the L level from the H level. With this configuration, the offset component resulting from the switching operation of the switch portion 12 is less likely to be added to the ramp signal VRAMP. As a result, the offset component resulting from the switching operation of the switch portion 12 is less likely to be added to each of the digital signal based on the amplified N signal and the digital signal based on the amplified S signal. In this case, the period related to processing of a photoelectric conversion signal is a period for which the potential of the ramp signal VRAMP changes.

In the third exemplary embodiment, the timing at which the timing control unit 50 makes the timing signal TIM have the L level is set to be prior to time T28; however, the timing may be set to be subsequent to time T28 at which the time-dependent potential change of the ramp signal VRAMP ends. With this configuration, the switch portion 12 does not perform a switching operation over a period for which the potential of the ramp signal VRAMP changes in a time-dependent manner. As a result, the offset component resulting from the switching operation of the switch portion 12 is less likely to be added to the ramp signal VRAMP.

As described in the first exemplary embodiment, a configuration may be made such that the switch portion 12 does not perform a switching operation while the signal φTX is at the H level also in the third exemplary embodiment.

In the third exemplary embodiment, the counter 607 supplies a count signal to the memory units 608 on the respective columns. Alternatively, a plurality of counters 607 may be provided for the respective comparators 604 at the respective columns.

In the image pickup apparatus according to the third exemplary embodiment, the switch portion 12 does not perform a switching operation over the period related to processing of a photoelectric conversion signal (e.g., a period for which the timing generator sets the potential of the ramp signal VRAMP to a potential from which the time-dependent potential change starts). Further, in the image pickup apparatus according to the third exemplary embodiment, a switching operation of the switch portion 12 may be stopped over a period for which the potential of the ramp signal VRAMP changes in a time-dependent manner. In this case, a variation in potential of the ramp signal VRAMP due to a switching operation of the switch portion 12 can be suppressed. The period for which the switch portion 12 of the image pickup apparatus according to the third exemplary embodiment does not perform a switching operation can be a period for which a digital signal of a signal based on a photoelectric conversion signal is obtained.

### Fourth Exemplary Embodiment

An image pickup apparatus according to a fourth exemplary embodiment will be described in terms of a difference from the image pickup apparatus according to the first exemplary embodiment.

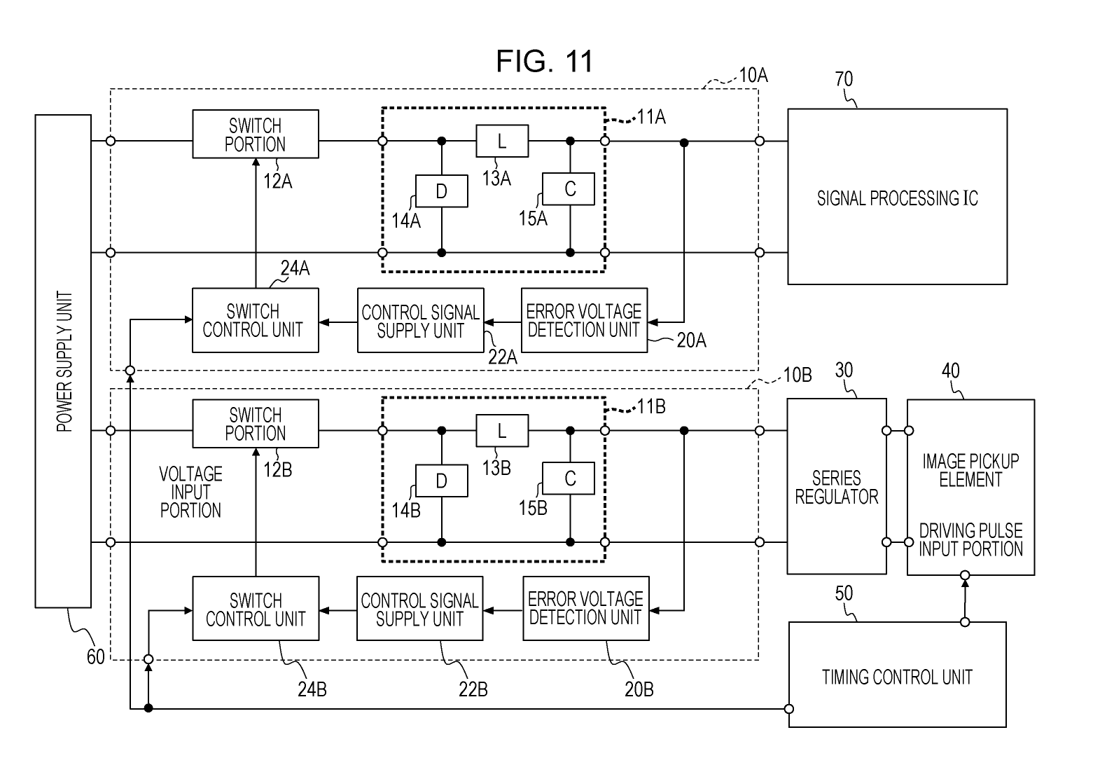

FIG. 11 is a diagram illustrating a configuration of the image pickup apparatus according to the fourth exemplary embodiment. In FIG. 11, components of the image pickup apparatus having similar functions as those illustrated in FIG. 1 are denoted by the same reference signs as those used in FIG. 1.

The image pickup apparatus according to the fourth exemplary embodiment includes a signal processing integrated circuit (IC) 70 which is mounted on a semiconductor substrate different from a semiconductor substrate having the image pickup element 40 mounted thereon. The signal processing IC 70 generates an image by using signals based on photoelectric conversion signals output by the image pickup element 40. The image pickup apparatus according to the fourth exemplary embodiment also includes a first voltage supply unit 10B and a second voltage supply unit 10A. The first voltage supply unit 10B includes a rectifying/smoothing unit 11B, a switch portion 12B, an error voltage detection unit 20B, a control signal supply unit 22B, and a switch control unit 24B. The rectifying/smoothing unit 11B includes an inductor 13B, a diode 14B, and a capacitive element 15B. The second voltage supply unit 10A includes a rectifying/smoothing unit 11A, a switch portion 12A, an error voltage detection unit 20A, a control signal supply unit 22A, and a switch control unit 24A. The rectifying/smoothing unit 11A includes an inductor 13A, a diode 14A, and a capacitive element 15A. The first and second voltage supply units 10B and 10A of the fourth exemplary embodiment respectively output, to the series regulator 30 and the signal processing IC 70, voltages obtained by lowering a power supply voltage input thereto from the power supply unit 60.

The image pickup apparatus according to the fourth exemplary embodiment includes the signal processing IC 70 which is supplied with a driving voltage by the second voltage supply unit 10A. A driving voltage is supplied to the image pickup element 40 from the first voltage supply unit 10B via the series regulator 30.

In the fourth exemplary embodiment, the timing control unit 50 outputs the common timing signal TIM to the switch control unit 24A of the second voltage supply unit 10A and the switch control unit 24B of the first voltage supply unit 10B. Accordingly, periods over which the switch portion 12A of the second voltage supply unit 10A and the switch portion 12B of the first voltage supply unit 10B do not perform a switching operation are identical.

The period for which the switch portion 12B of the first voltage supply unit 10B does not perform a switching operation can be set to be identical to the period described in the first to third exemplary embodiments.

In the image pickup apparatus according to the fourth exemplary embodiment, periods over which the switch portions 12A and 12B do not perform a switching operation are made identical. With this configuration, a noise component resulting from a switching operation of the switch portion 12A and the switch portion 12B contained in a photoelectric conversion signal of the image pickup element 40 or a signal based on the photoelectric conversion signal can be reduced.

Also, in the case where the semiconductor substrate having the signal processing IC 70 mounted thereon and the semiconductor substrate having the image pickup element 40 mounted thereon are provided in the vicinity of each other, noise due to a variation in the driving voltage of the signal processing IC 70 is likely to propagate to the image pickup element 40. Even in such a case, the image pickup apparatus according to the fourth exemplary embodiment can reduce the variation in the driving voltage in the signal processing IC 70, and thus can reduce noise propagated from the signal processing IC 70 to the image pickup element 40.

### Fifth Exemplary Embodiment

An image pickup apparatus according to a fifth exemplary embodiment will be described in terms of a difference from the image pickup apparatus according to the first exemplary embodiment. A difference between the fifth exemplary embodiment and the first exemplary embodiment is the configuration of the voltage supply unit.

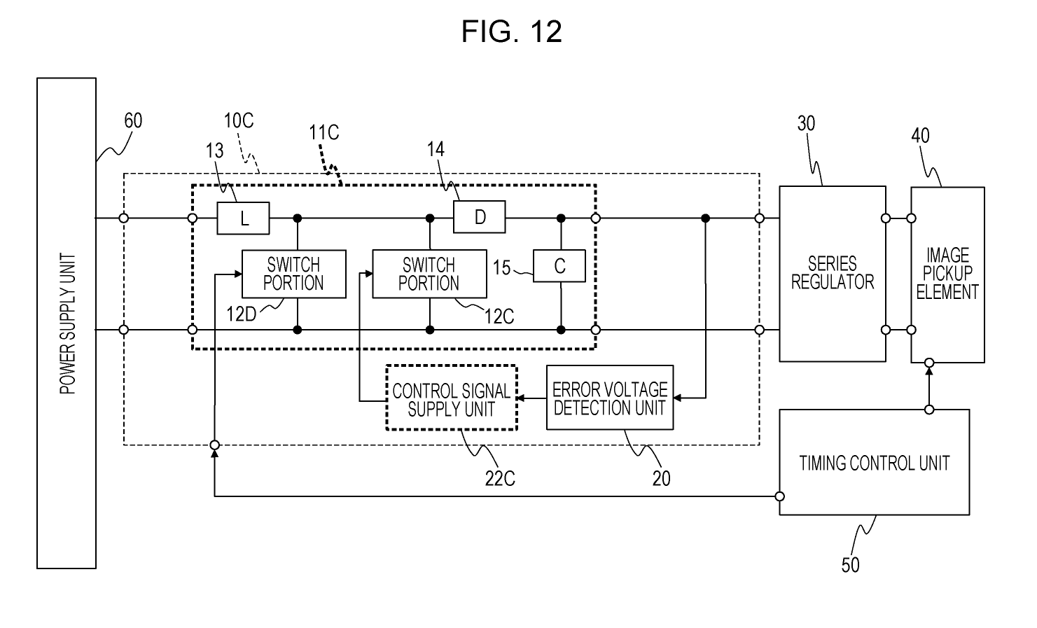

FIG. 12 is a diagram illustrating a configuration of the image pickup apparatus according to the fifth exemplary embodiment. In FIG. 12, components of the image pickup apparatus having similar functions as those illustrated in FIG. 1 are denoted by the same reference signs as those used in FIG. 1.

A voltage supply unit 10C according to the fifth exemplary embodiment includes a rectifying/smoothing unit 11C, the error voltage detection unit 20, and a control signal supply unit 22C.

The rectifying/smoothing unit 11C includes the inductor 13, the diode 14, the capacitive element 15, a switch portion 12C, and a switch portion 12D.

The control signal supply unit 22C according to the fifth exemplary embodiment controls a switching operation of the switch portion 12C. The timing control unit 50 outputs, to the switch portion 12D, the timing signal TIM for controlling a switching operation of the switch portion 12D.

In the voltage supply unit 10C according to the fifth exemplary embodiment, the switch portion 12C performs a switching operation in accordance with a signal supplied from the control signal supply unit 22C. On the other hand, as described in the first to third exemplary embodiments, the timing control unit 50 keeps the timing signal TIM at the H level over the period related to generation or processing of a photoelectric conversion signal. Upon receipt of the high-level timing signal TIM, the switch portion 12D enters a conducting state. As a result, even if the switch portion 12C performs a switching operation, the operation of the capacitive element 15 is not switched between charging and discharging because the switch portion 12D is in the conducting state. A period for which the operation of the capacitive element 15 is not switched between charging and discharging can be set to be identical to the period for which the timing signal TIM is kept at the H level described in the first to third exemplary embodiments. With this configuration, the image pickup apparatus according to the fifth exemplary embodiment can also obtain benefits similar to those of the image pickup apparatuses described in the first and third exemplary embodiments.

In each of the exemplary embodiments described herein, the driving voltage output by the voltage supply unit 10, 10B, or 10C are supplied to the image pickup element 40 via the series regulator 30 for rectification and smoothing. The exemplary embodiments described herein are not limited to this example and the driving voltage output by the voltage supply unit 10, 10B, or 10C may be supplied directly to the image pickup element 40.

Note that each of the exemplary embodiments of the present invention is merely an example for implementing the present invention, and the technical scope of the present invention should not be restrictively interpreted thereby. That is, the present invention can be implemented in various forms without departing from the technical spirit or major features thereof.

Exemplary embodiments of the present invention can provide an image pickup apparatus that generates a photoelectric conversion signal or a signal based on a photoelectric conversion signal in which noise produced by a switching operation performed by a power supply unit is reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-267147, filed Dec. 25, 2013, which is hereby incorporated by reference herein in its entirety.

What is claimed is:

1. An image pickup apparatus comprising:
an image pickup element including pixels each configured to generate a photoelectric conversion signal based on an electric charge resulting from photoelectric conversion on incident light;
a first voltage supply unit configured to receive an input voltage and to supply the image pickup element with a driving voltage obtained by changing a voltage value of the input voltage; and
a controller configured to control an operation performed by the first voltage supply unit, wherein
the first voltage supply unit includes
a first capacitive element, and
a first switch portion configured to perform a switching operation for switching an operation of the first capacitive element between charging and discharging,
the driving voltage is a voltage obtained by changing a voltage value of the input voltage through the switching operation, and
the controller performs control so that the first switch portion does not perform the switching operation over a period related to generation of a photoelectric conversion signal or a period related to processing of a photoelectric conversion signal.

2. The image pickup apparatus according to claim 1, further comprising
a timing controller configured to output, to the controller, a timing signal representing the period related to generation of a photoelectric conversion signal or the period related to processing of a photoelectric conversion signal, wherein
the controller performs control in accordance with the timing signal so that the first switch portion does not perform the switching operation.

3. The image pickup apparatus according to claim 1, wherein
each of the pixels includes
a photoelectric conversion portion configured to perform the photoelectric conversion to generate the electric charge,
a floating diffusion portion to which the electric charge is transferred from the photoelectric conversion portion, and
a pixel output portion configured to output the photoelectric conversion signal based on the electric charge transferred to the floating diffusion portion, and
the period related to generation of a photoelectric conversion signal is a period for which the electric charge is transferred from the photoelectric conversion portion to the floating diffusion portion.

4. The image pickup apparatus according to claim 2, wherein
each of the pixels includes
a photoelectric conversion portion configured to perform the photoelectric conversion to generate the electric charge,
a floating diffusion portion to which the electric charge is transferred from the photoelectric conversion portion, and
a pixel output portion configured to output the photoelectric conversion signal based on the electric charge transferred to the floating diffusion portion, and
the period related to generation of a photoelectric conversion signal is a period for which the electric charge is transferred from the photoelectric conversion portion to the floating diffusion portion.

5. The image pickup apparatus according to claim 1, wherein
the image pickup element further includes an analog-to-digital converter configured to convert the photoelectric conversion signal into a digital signal,
the analog-to-digital converter includes
a ramp signal supply unit configured to generate a ramp signal having a potential that changes in a time-dependent manner,
a comparator configured to generate a comparison result signal obtained by comparing a signal level of the photoelectric conversion signal with a signal level of the ramp signal, and
a counter configured to generate a count signal representing a count of a clock signal, and
the period related to processing of a photoelectric conversion signal is a period for which the potential of the ramp signal is set to a potential from which the time-dependent potential change of the ramp signal starts.

6. The image pickup apparatus according to claim 2, wherein
the image pickup element further includes an analog-to-digital converter configured to convert the photoelectric conversion signal into a digital signal,
the analog-to-digital converter includes
a ramp signal supply unit configured to generate a ramp signal having a potential that changes in a time-dependent manner,
a comparator configured to generate a comparison result signal obtained by comparing a signal level of the photoelectric conversion signal with a signal level of the ramp signal, and
a counter configured to generate a count signal representing a count of a clock signal, and
the period related to processing of a photoelectric conversion signal is a period for which the potential of the ramp signal is set to a potential from which the time-dependent potential change of the ramp signal starts.

7. The image pickup apparatus according to claim 1, wherein
the image pickup element further includes an analog-to-digital converter configured to convert the photoelectric conversion signal into a digital signal,
the analog-to-digital converter includes
a ramp signal supply unit configured to generate a ramp signal having a potential that changes in a time-dependent manner,
a comparator configured to generate a comparison result signal obtained by comparing a signal level of the photoelectric conversion signal with a signal level of the ramp signal, and
a counter configured to generate a count signal representing a count of a clock signal, and
the period related to processing of a photoelectric conversion signal is a period for which the potential of the ramp signal changes.

8. The image pickup apparatus according to claim 2, wherein
the image pickup element further includes an analog-to-digital converter configured to convert the photoelectric conversion signal into a digital signal,
the analog-to-digital converter includes
a ramp signal supply unit configured to generate a ramp signal having a potential that changes in a time-dependent manner,
a comparator configured to generate a comparison result signal obtained by comparing a signal level of the photoelectric conversion signal with a signal level of the ramp signal, and
a counter configured to generate a count signal representing a count of a clock signal, and
the period related to processing of a photoelectric conversion signal is a period for which the potential of the ramp signal changes.

9. The image pickup apparatus according to claim 7, wherein the controller performs control so that the first switch portion does not perform the switching operation over a period for which the potential of the ramp signal is set to a potential from which the time-dependent potential change of the ramp signal starts.

10. The image pickup apparatus according to claim 8, wherein the controller performs control so that the first switch portion does not perform the switching operation over a period for which the potential of the ramp signal is set to a potential from which the time-dependent potential change of the ramp signal starts.

11. The image pickup apparatus according to claim 1, further comprising:
a signal processing integrated circuit configured to process a signal output by the image pickup element and to generate an image; and
a second voltage supply unit configured to supply a driving voltage to the signal processing integrated circuit, wherein
the second voltage supply unit includes
a second capacitive element, and
a second switch portion configured to perform a switching operation for switching an operation of the second capacitive element between charging and discharging,
the second voltage supply unit generates the driving voltage supplied to the signal processing integrated circuit through the switching operation performed by the second switch portion, and
the controller performs control so that the second switch portion does not perform the switching operation over a period for which the controller performs control so that the first switch portion does not perform the switching operation.

12. The image pickup apparatus according to claim 2, further comprising:
a signal processing integrated circuit configured to process a signal output by the image pickup element and to generate an image; and
a second voltage supply unit configured to supply a driving voltage to the signal processing integrated circuit, wherein
the second voltage supply unit includes
a second capacitive element, and
a second switch portion configured to perform a switching operation for switching an operation of the second capacitive element between charging and discharging,
the second voltage supply unit generates the driving voltage supplied to the signal processing integrated circuit through the switching operation performed by the second switch portion, and
the controller performs control so that the second switch portion does not perform the switching operation over a period for which the controller performs control so that the first switch portion does not perform the switching operation.

13. The image pickup apparatus according to claim 3, further comprising:
a signal processing integrated circuit configured to process a signal output by the image pickup element and to generate an image; and
a second voltage supply unit configured to supply a driving voltage to the signal processing integrated circuit, wherein
the second voltage supply unit includes
a second capacitive element, and
a second switch portion configured to perform a switching operation for switching an operation of the second capacitive element between charging and discharging,
the second voltage supply unit generates the driving voltage supplied to the signal processing integrated circuit through the switching operation performed by the second switch portion, and
the controller performs control so that the second switch portion does not perform the switching operation over a period for which the controller performs control so that the first switch portion does not perform the switching operation.

14. A method for driving an image pickup apparatus, the image pickup apparatus including an image pickup element including pixels each configured to generate a photoelectric conversion signal based on an electric charge resulting from photoelectric conversion on incident light and a voltage supply unit configured to receive an input voltage and to supply the image pickup element with a driving voltage obtained by changing a voltage value of the input voltage, the voltage supply unit including a first capacitive element, the method comprising:
changing the voltage value of the input voltage by switching an operation of the first capacitive element between charging and discharging to obtain the driving voltage; and
performing control so that the operation of the first capacitive element is not switched between charging and discharging over a period related to generation a photoelectric conversion signal or a period related to processing of a photoelectric conversion signal.

15. The method according to claim 14, further comprising:
performing a switching operation of the first capacitive element between charging and discharging; and
performing control so that the operation of the first capacitive element is not switched between charging and discharging over the period related to generation a photoelectric conversion signal or the period related to processing of a photoelectric conversion signal.

16. The method according to claim 14, further comprising:
converting the photoelectric conversion signal into a digital signal;
generating a ramp signal having a potential that changes in a time-dependent manner;
generating a comparison result signal obtained by comparing a signal level of the photoelectric conversion signal with a signal level of the ramp signal; and
generating a count signal representing a count of a clock signal,
wherein the period related to processing of a photoelectric conversion signal is a period for which the potential of the ramp signal is set to a potential from which the time-dependent potential change of the ramp signal starts.

17. The method according to claim 15, further comprising:
converting the photoelectric conversion signal into a digital signal;
generating a ramp signal having a potential that changes in a time-dependent manner;
generating a comparison result signal obtained by comparing a signal level of the photoelectric conversion signal with a signal level of the ramp signal; and
generating a count signal representing a count of a clock signal,
wherein the period related to processing of a photoelectric conversion signal is a period for which the potential of the ramp signal changes.

18. The method according to claim 17, further comprising performing control so that the operation of the first capacitive element is not switched between charging and discharging over a period for which the potential of the ramp signal is set to a potential from which the time-dependent potential change of the ramp signal starts.

19. The method according to claim 14, further comprising:
generating an image by a signal processing integrated circuit based on a signal output by the image pickup element;
supplying a driving voltage to the signal processing integrated circuit;
performing a switching operation for switching an operation of a second capacitive element between charging and discharging;
generating the driving voltage supplied to the signal processing integrated circuit through the switching operation performed by the second capacitive element; and
performing control so that the operation of the second capacitive element is not switched between charging and discharging over a period for which control is performed so that the operation of the first capacitive element is not switched between charging and discharging.

20. The method according to claim 15, further comprising:
generating an image by a signal processing integrated circuit based on a signal output by the image pickup element;
supplying a driving voltage to the signal processing integrated circuit;
performing a switching operation of a second capacitive element between charging and discharging,
generating the driving voltage supplied to the signal processing integrated circuit through the switching operation by the second capacitive element; and
performing control so that the operation of the second capacitive element is not switched between charging and discharging over a period for which control is performed so that the operation of the first capacitive element is not switched between charging and discharging.
